(19) United States
(12) Patent Application Publication
(10) Pub. No.: US 2025/0285148 A1
(43) Pub. Date: Sep. 11, 2025

(54) METHOD AND DEVICE FOR PROVIDING INFORMATION RELATED TO GRADE FOR MIXED IRON SCRAP

(71) Applicants: LG CNS CO., LTD., Seoul (KR); DaehanSteel, Busan (KR)

(72) Inventors: Beom Seock KIM, Busan (KR); Tae Young CHOI, Busan (KR); Hee Jae LEE, Seoul (KR)

(21) Appl. No.: 18/991,147

(22) Filed: Dec. 20, 2024

(30) Foreign Application Priority Data
Mar. 6, 2024 (KR) 10-2024-0031940

(51) Int. Cl. G06Q 30/0283; G06Q 10/30

(52) U.S. Cl. CPC G06Q 30/0283; G06Q 10/30

(57) ABSTRACT

A method for providing information related to a grade for mixed iron scrap includes obtaining policy information on a grade for mixed iron scrap for a first type of iron scrap and a second type of iron scrap; determining a normal purchase unit price for each type based on the policy information; determining a weighted average unit price for the mixed iron scrap based on a percentage of the first type of iron scrap, a percentage of the second type of iron scrap, and the normal purchase unit prices; and determining the grade for the mixed iron scrap to be a first grade corresponding to the first type of iron scrap or a second grade corresponding to the second type of iron scrap based on a result of comparing a threshold weighted average unit price determined based on the policy information with the weighted average unit price.

### CROSS-REFERENCE TO RELATED APPLICATION

This application claims priority to and the benefit of Korean Patent Application No. 10-2024-0031940, filed on Mar. 6, 2024, the disclosure of which is incorporated herein by reference in its entirety.

### BACKGROUND

### 1. Field of the Invention

The technical field of the present disclosure relates to a device for providing information related to a grade for iron scrap in which various types of iron are mixed, a method thereof, and a computer-readable recording medium on which a program for performing the method on a computer is recorded, and relates to a technical field for determining a grade for mixed iron scrap based on a percentage of mixed iron scrap and a purchase unit price.

### 2. Background

Generally, iron scrap refers to residual materials that are discarded during the process of producing and processing steel and collected, recovered, and then reused in steel production, and the iron scrap is one of three major raw materials for the steel industry, along with iron ore and coking coal. Iron scrap is attracting attention because companies can save money by recovering discarded iron and reusing the iron in steel production and make environmentally friendly business through sustainable management. However, iron scrap that is loaded onto trucks and delivered often contains a mixture of various types of iron, and in the case of conventional technology, there is a problem in that a process of inspecting mixed iron scrap and determining its grade is performed manually, which results in low accuracy and requires a long inspection time. Moreover, determining the grade of mixed iron scrap requires accurate measurement data, such as the weight of different scrap types and their proportions in the mixture, which is often unavailable in traditional methods, leading to inconsistencies and inaccuracies. Therefore, there is a need for a technology for overcoming the limitations described above and determining and providing a grade for mixed iron scrap according to an acceptable mixed loading criterion for iron scrap by steelmaker and a purchase unit price for each grade.

### SUMMARY OF THE INVENTION

The present disclosure is directed to providing a device that determines a grade for iron scrap in which multiple types of iron are mixed and supports a user to receive related information.

According to an aspect of the present disclosure, there is provided a method of providing information related to a grade for mixed iron scrap using a device, which includes obtaining, by a receiving unit, policy information on criteria for determining a grade for mixed iron scrap in which a first type of iron scrap and a second type of iron scrap are mixed, determining, by a processor, a normal purchase unit price for each of the first type of iron scrap and the second type of iron scrap on the basis of the policy information, determining, by the processor, a weighted average unit price for the mixed iron scrap on the basis of a percentage of the first type of iron scrap, a percentage of the second type of iron scrap, and the normal purchase unit prices, and determining, by the processor, the grade for the mixed iron scrap to be either a first grade corresponding to the first type of iron scrap or a second grade corresponding to the second type of iron scrap on the basis of a result of comparing a threshold weighted average unit price determined based on the policy information with the weighted average unit price.

The policy information may include information on an acceptable mixed loading ratio indicating an acceptable mixed loading criterion between a plurality of iron scrap grades for the mixed iron scrap.

The method may further include determining, by the processor, the lowest normal purchase unit price, which represents the lowest value of the normal purchase unit price for the first type of iron scrap, on the basis of the policy information, wherein the lowest normal purchase unit price may represent the threshold weighted average unit price.

The first grade of the first type of iron scrap may be higher than the second grade of the second type of iron scrap.

The determining of the grade for the mixed iron scrap to be either the first grade or the second grade may include determining, by the processor, the grade for the mixed iron scrap to be the first grade when the weighted average unit price is greater than the lowest normal purchase unit price, and determining, by the processor, the grade for the mixed iron scrap to be the second grade when the weighted average unit price is less than the lowest normal purchase unit price.

The determining of the lowest normal purchase unit price may include determining, by the processor, a purchase unit price difference value representing a difference between a first normal purchase unit price for the first type of iron scrap and a second normal purchase unit price for the second type of iron scrap, and determining, by the processor, the lowest normal purchase unit price by applying the acceptable mixed loading ratio to the purchase unit price difference value.

The determining of the lowest normal purchase unit price by applying the acceptable mixed loading ratio to the purchase unit price difference value may include determining, by the processor, an acceptable threshold value corresponding to the product of the purchase unit price difference value and an unacceptable ratio determined according to the acceptable mixed loading ratio, and determining, by the processor, the lowest normal purchase unit price to correspond to a value obtained by subtracting the acceptable threshold value from the first normal purchase unit price.

According to another aspect of the present disclosure, there is provided a device for providing information related to a grade for mixed iron scrap, which includes a receiving unit configured to obtain policy information on criteria for determining a grade for mixed iron scrap in which a first type of iron scrap and a second type of iron scrap are mixed, and a processor that is configured to determine a normal purchase unit price for each of the first type of iron scrap and the second type of iron scrap on the basis of the policy information, determine a weighted average unit price for the mixed iron scrap on the basis of a percentage of the first type of iron scrap, a percentage of the second type of iron scrap, and the normal purchase unit prices, and determine the grade for the mixed iron scrap to be either a first grade corresponding to the first type of iron scrap or a second grade corresponding to the second type of iron scrap on the basis of a result of comparing a threshold weighted average unit price determined based on the policy information with the weighted average unit price.

The policy information may include information on an acceptable mixed loading ratio indicating an acceptable mixed loading criterion between a plurality of iron scrap grades for the mixed iron scrap.

The processor may determine the lowest normal purchase unit price, which represents the lowest value of the normal purchase unit price for the first type of iron scrap, on the basis of the policy information.

The processor may determine the grade for the mixed iron scrap to be the first grade when the weighted average unit price is greater than the lowest normal purchase unit price, and determine the grade for the mixed iron scrap to be the second grade when the weighted average unit price is less than the lowest normal purchase unit price.

The processor may determine a purchase unit price difference value representing a difference between a first normal purchase unit price for the first type of iron scrap and a second normal purchase unit price for the second type of iron scrap and determine the lowest normal purchase unit price by applying the acceptable mixed loading ratio to the purchase unit price difference value.

According to still another aspect of the present disclosure, there is provided a computer-readable non-transitory recording medium on which a program is recorded, the program comprising instructions that, when executed by a processor, cause the processor to: obtain policy information on criteria for determining a grade for mixed iron scrap in which a first type of iron scrap and a second type of iron scrap are mixed; determine a normal purchase unit price for each of the first type of iron scrap and the second type of iron scrap based on the policy information; determine a weighted average unit price for the mixed iron scrap based on a percentage of the first type of iron scrap, a percentage of the second type of iron scrap, and the normal purchase unit price for each type of iron scrap; and determine the grade for the mixed iron scrap to be either a first grade corresponding to the first type of iron scrap or a second grade corresponding to the second type of iron scrap based on a result of comparing a threshold weighted average unit price determined based on the policy information with the weighted average unit price.

### BRIEF DESCRIPTION OF THE DRAWINGS

The above and other aspects, features and advantages of the present disclosure will become more apparent to those of ordinary skill in the art by describing exemplary embodiments thereof in detail with reference to the accompanying drawings, in which:

FIG. 1 is a block diagram schematically illustrating a configuration of a device for providing information related to a grade for mixed iron scrap according to an embodiment of the present disclosure;

FIG. 2 is a flowchart illustrating operations in which the device according to an embodiment of the present disclosure provides information related to a grade for mixed iron scrap;

FIG. 3 is an example of a screen display through which the device according to an embodiment of the present disclosure obtains policy information;

FIG. 4 is an example of a table showing a normal purchase unit price for iron scrap based on the policy information and the lowest normal purchase unit price which are determined and provided by the device according to an embodiment of the present disclosure;

FIG. 5 is an example of a screen display through which the device according to an embodiment of the present disclosure provides a result of determination of a grade for mixed iron scrap;

FIG. 6 is an example of a table showing score cards determined based on policy information and provided by the device according to an embodiment of the present disclosure;

FIG. 7 is an example of a loading device on which mixed iron scrap is loaded according to an embodiment of the present disclosure; and

FIG. 8 is a view of an example of the loading device on which mixed iron scrap is loaded according to an embodiment of the present disclosure from above.

FIG. 9 illustrates a simplified view of a device including a receiving unit and a processor according to an embodiment of the present disclosure.

### DETAILED DESCRIPTION OF EXEMPLARY EMBODIMENTS

A detailed description of embodiments is provided below along with accompanying figures. The scope of this disclosure is limited by the claims and encompasses numerous alternatives, modifications and equivalents. Although steps of various processes are presented in a given order, embodiments are not necessarily limited to being performed in the listed order. In some embodiments, certain operations may be performed simultaneously, in an order other than the described order, or not performed at all.

Terms used herein are provided only to describe the embodiments of the present disclosure and not for purposes of limitation. In this specification, the singular forms include the plural forms unless the context clearly indicates otherwise. It will be understood that terms “comprise” and/or “comprising” used herein specify some stated components, but do not preclude the presence or addition of one or more other components. Like reference numerals throughout the specification denote like components, and “and/or” includes each and every combination of one or more of the above-describe components. It should be understood that although the terms “first,” “second,” etc. may be used herein to describe various components, these components are not limited by these terms. The terms are only used to distinguish one component from another component. Therefore, it should be understood that a first component to be described below may be a second component within the technical scope of the present disclosure.

Unless otherwise defined, all terms including technical and scientific terms used herein have the same meaning as commonly understood by those skilled in the art. Further, it should be further understood that terms, such as those defined in commonly used dictionaries, should not be interpreted in an idealized or overly formal sense unless expressly so defined herein.

Spatially relative terms “below,” “beneath,” “lower,” “above,” “upper,” etc., may be used to facilitate the description of a relationship between one component and other components as illustrated in the accompanying drawings. The spatially relative terms should be understood to include different directions of the element during use or operation in addition to the direction illustrated in the accompanying drawings. For example, when a component illustrated in the drawing are flipped, a component described as “below” or “beneath” another component may end up being placed “above” the other component. Therefore, an exemplary term “below” may include both downward and upward directions. Components may be arranged in different directions so that spatially relative terms may be interpreted according to the arrangement.

Hereinafter, embodiments will be described in detail with reference to the accompanying drawings.

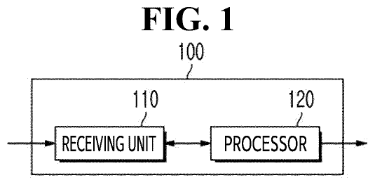

FIG. 1 is a block diagram schematically illustrating a configuration of a device 100 for providing information related to a grade for mixed iron scrap according to an embodiment of the present disclosure.

Referring to FIG. 1, the device 100 that provides the information related to the grade for the mixed iron scrap may include a receiving unit 110 and a processor 120

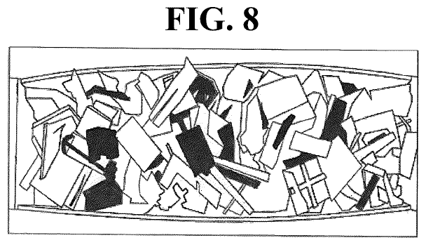

According to an embodiment, the receiving unit 110 may obtain policy information on criteria for determining a grade for mixed iron scrap in which a first type of iron scrap and a second type of iron scrap are mixed. In an embodiment, in addition to policy information, the receiving unit also receives measurement data that provides information on the physical characteristics of the mixed scrap. The measurement data includes, but is not limited to, the total weight of the mixed iron scrap, the weight of each type of scrap, and their respective proportions in the mixture. The measure data may be obtained from any number of sources including a loading device that will be described below in FIG. 8. Alternatively, the receiving unit may receive the measurement data from external devices integrated with a loading system.

The processor 120 according to an embodiment may determine a normal purchase unit price for each of the first type of iron scrap and the second type of iron scrap on the basis of the policy information. Further, the processor 120 may determine a weighted average unit price for the mixed iron scrap on the basis of a percentage of the first type of iron scrap, a percentage of the second type of iron scrap, and the normal purchase unit prices. Further, the processor 120 may determine the grade for the mixed iron scrap to be either a first grade corresponding to the first type of iron scrap or a second grade corresponding to the second type of iron scrap on the basis of a result of comparing a threshold weighted average unit price determined based on the policy information with the weighted average unit price.

Further, the device 100 that provides the information related to the grade for the mixed iron scrap may be combined with various conventional network combinations such as the Internet, a mobile communication network, etc. in the process in which the receiving unit 110 obtains the policy information on the criteria for determining the grade for the mixed iron scrap, and the processor 120 determines the normal purchase unit price for the iron scrap, determines the weighted average unit price for the mixed iron scrap on the basis of the percentage of the first type of iron scrap, the percentage of the second type of iron scrap, and the normal purchase unit prices, determines the grade for the mixed iron scrap to be either the first grade corresponding to the first type of iron scrap or the second grade corresponding to the second type of iron scrap, and provides the information related to the grade for the iron scrap, and it should be noted that there is no special limitation on the networks.

In addition, it should be understood by those skilled in the art that other general components other than those illustrated in FIG. 1 may be further included in the device 100 that provides the information related to the grade for the mixed iron scrap. For example, the device 100 that provides the information related to the grade for the mixed iron scrap may further include a memory (not illustrated) that stores the policy information on the criteria for determining the grade for the mixed iron scrap, grade information corresponding to the mixed iron scrap, etc., and may further include a transmitting unit (not illustrated) that provides the grade information of the mixed iron scrap or a display unit (not illustrated) that displays the grade information of the mixed iron scrap. Alternatively, it will be understood by those skilled in the art that in another embodiment, some of the components illustrated in FIG. 1 may be omitted.

The device 100 that provides the information related to the grade for the mixed iron scrap according to an embodiment may be used by a user, may be linked with any type of handheld-based wireless communication devices equipped with a touch screen panel, such as a mobile phone, a smartphone, a personal digital assistant (PDA), a portable multimedia player (PMP), a tablet computer, etc., and in addition, may be included in or linked with a device that has a foundation for installing and executing an application, such as a desktop personal computer (PC), a tablet computer, a laptop computer, an Internet Protocol television (IPTV) including a set-top box.

The device 100 that provides the information related to the grade for the mixed iron scrap may be implemented as a terminal such as a computer or the like that operates through a computer program to realize the functions described in this specification.

The device 100 that provides the information related to the grade for the mixed iron scrap according to an embodiment may include a system (not illustrated) that provides classification information on iron scrap and a related server (not illustrated), but the present disclosure is not limited thereto. The server according to an embodiment may support an application that provides a service providing information related to the grade for the mixed iron scrap.

Hereinafter, an example in which the device 100 that provides the information related to the grade for the mixed iron scrap according to an embodiment independently obtains and provides information results related to a preset grade for mixed iron scrap is mainly described, but as described above, the device 100 may perform the above function in conjunction with the server. That is, the device 100 that provides the information related to the grade for the mixed iron scrap according to an embodiment and the server may be implemented in an integrated manner in terms of their functions, and the server may be omitted, and it can be seen that the present disclosure is not limited to any an embodiment.

In an embodiment, the device 100 that provides the information related to the grade for the mixed iron scrap and the server may be linked with each other, and by performing the process for determining the grade for the mixed iron scrap and the process for providing information on the determined grade for the mixed iron scrap, a configuration for providing the information on the mixed iron scrap may be performed by the server or by the device 100 that provides the information related to the grade for the mixed iron scrap. For example, the device 100 that provides the information related to the grade for the mixed iron scrap may operate as a server, and the device 100 that provides the information related to the grade for the mixed iron scrap and the server are hereinafter collectively referred to as the device 100 that provides the information related to the grade for the mixed iron scrap.

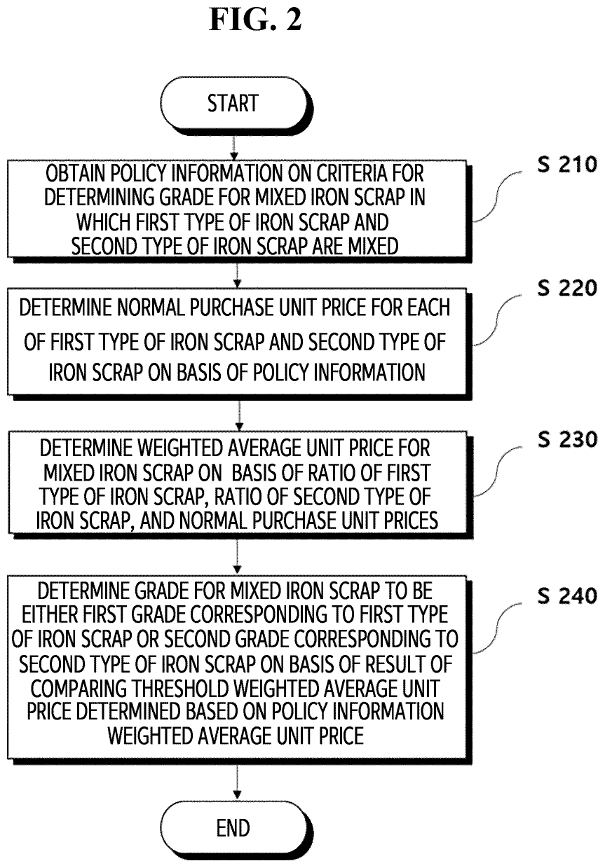

FIG. 2 is a flowchart illustrating operations in which the device 100 according to an embodiment of the present disclosure provides information related to a grade for mixed iron scrap.

Referring to operation S210, the device 100 according to an embodiment may obtain policy information on criteria for determining a grade for mixed iron scrap in which a first type of iron scrap and a second type of iron scrap are mixed. In an embodiment, the device 100 may obtain policy information corresponding to each of a plurality of company accounts. As used herein, the term “policy information” refers to data that defines acceptable criteria or rules for classifying and grading mixed iron scrap. In this example, the policy information may include the type of iron scrap, a normal purchase unit price for each of a plurality of pieces of iron scrap, a plurality of iron scrap grades, etc. Further, in an embodiment, the device 100 may obtain policy information including information on an acceptable mixed loading ratio indicating an acceptable mixed loading criterion between the plurality of iron scrap grades for the mixed iron scrap. As used herein, the term “acceptable mixed loading ratio” represents maximum proportion of different types of iron scrap that can be mixed while still qualifying for a particular grade.

Referring to operation S220, the device 100 according to an embodiment may determine a normal purchase unit price for each of the first type of iron scrap and the second type of iron scrap based on the policy information. In an embodiment, the device 100 may obtain a normal purchase unit price for each of the plurality of pieces of iron scrap based on the policy information. Therefore, the normal purchase unit price for each of the first type of iron scrap and the second type of iron scrap may be determined.

Referring to operation S230, the device 100 according to an embodiment may determine a weighted average unit price for the mixed iron scrap based on a percentage of the first type of iron scrap, a percentage of the second type of iron scrap, and the normal purchase unit prices for each type of iron scrap. In an embodiment, the device 100 may obtain iron scrap classification information including information such as the type of mixed iron scrap that is mixed in and loaded on a loading device from the receiving unit 110, iron scrap grade information corresponding to a plurality of iron scrap types, a percentage of each iron scrap of the mixed iron scrap, etc. Therefore, the device 100 may determine the weighted average unit price for the mixed iron scrap based on the obtained type of the mixed iron scrap, a mixing ratio corresponding to each of the plurality of iron scrap types, and the normal purchase unit prices. In an embodiment,

Referring to operation S240, the device 100 according to an embodiment may determine the grade for the mixed iron scrap to be either a first grade corresponding to the first type of iron scrap or a second grade corresponding to the second type of iron scrap based on a result of comparing a threshold weighted average unit price determined based on the policy information with the weighted average unit price.

In an embodiment, the device 100 may determine the lowest normal purchase unit price, which represents the lowest value of the normal purchase unit price for the first type of iron scrap, based on the policy information. In an embodiment, the lowest normal purchase unit price may represent the threshold weighted average unit price.

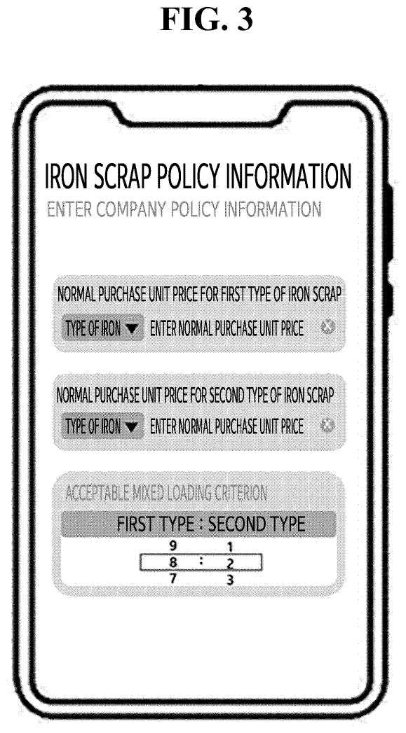

FIG. 3 is an example of a screen display through which the device 100 according to an embodiment of the present disclosure obtains policy information.

Referring to FIG. 3, in an embodiment, the device 100 may obtain the types such to be the first type of iron scrap and the second type of iron scrap and the normal purchase unit price corresponding to each type of iron scrap. Further, the device 100 may obtain the acceptable mixed loading ratio indicating the acceptable mixed loading criterion for the mixed iron scrap. For example, when the acceptable mixed loading ratio of the first type of iron scrap to the second type of iron scrap is 7:3, the device 100 may determine an allowable ratio as 70% and an unacceptable ratio as 30%. Therefore, when the percentage of the first type of iron scrap in the mixed iron scrap mixed in and loaded on the loading device is 70% or more, the mixed iron scrap may be determined to be the first grade corresponding to the first type of iron scrap. Further, when the percentage of the first type of iron scrap the ratio in the mixed iron scrap is 70% or less, the mixed iron scrap may be determined to be the second grade corresponding to the second type of iron scrap.

In an embodiment, the first grade of the first type of iron scrap may be higher than the second grade of the second type of iron scrap. Specifically, the device 100 may determine the grade of the iron scrap as a higher grade as a weight of the iron scrap increases. More specifically, the first type of iron scrap may be a type of iron scrap that is heavier than the second type of iron scrap. For example, the first type of iron scrap may correspond to heavyweight iron scrap, and the second type of iron scrap may correspond to lightweight iron scrap. Therefore, the first type of iron scrap may have a higher normal purchase unit price than the second type of iron scrap, and the first type of iron scrap may have a higher grade than the second type of iron scrap.

In an embodiment, the device 100 may obtain information on a weight of the iron scrap, a thickness of the iron scrap, and a length of the iron scrap. Further, the device 100 may determine the grade for the iron scrap using weights that are differently assigned to the weight of the iron scrap, the thickness of the iron scrap, and the length of the iron scrap. For example, the device 100 may determine the grade for the mixed iron scrap by assigning the greatest weight to the thickness of the iron scrap. Iron scrap is a waste product of iron or iron products, and is a raw material for refining and regenerating steel and is a raw material for recycling waste cast iron purchased from other places. Generally, the less impurities iron contains, the better the quality is considered to be. Since it can be determined that it is desirable to consider the weight of iron scrap as being heavier the less impurities such as carbon it contains, the device 100 may determine the grade for the iron scrap by assigning the highest weight to the iron scrap that is heavier.

In another embodiment the device 100 may determine the grade for the iron scrap by assigning the greatest weight to the length of the iron scrap. The iron scrap should be melted while charged into an electric furnace. That is, the iron scrap should be melted while charged into a blast furnace or the like, and in this process, iron scrap that is too large should undergo a separate processing process to be charged into the electric furnace, and thus iron scrap cut into a size for charging into the electric furnace may be most preferred. Therefore, the device 100 may determine the grade for the iron scrap by assigning the greatest weight to the length of the iron scrap.

In an embodiment, as described above, since the types of iron scrap preferred by users corresponding to multiple company accounts may differ, the device 100 determines the grade for the iron scrap by assigning different weights to iron scrap grade determination factors according to each situation, and thus the user satisfaction can be effectively improved.

In an embodiment, in the operation of determining the grade for the mixed iron scrap to be either the first grade or the second grade, when the weighted average unit price is greater than the lowest normal purchase unit price, the device 100 may determine the grade for the mixed iron scrap to be the first grade. In an embodiment, the lowest normal purchase unit price may represent the lowest normal purchase unit price for the first type of iron scrap. As described above in operation S240, the device 100 may determine the grade for the mixed iron scrap based on a result of comparing the lowest normal purchase unit price representing the threshold weighted average unit price determined based on the policy information with the weighted average unit price for the mixed iron scrap.

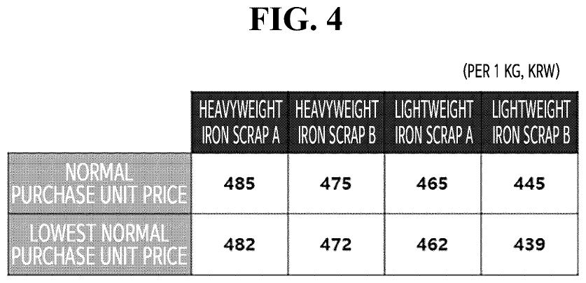

FIG. 4 is an example of a table showing a normal purchase unit price for iron scrap based on the policy information and the lowest normal purchase unit price which are determined and provided by the device according to an embodiment of the present disclosure.

Referring to FIG. 4, the device 100 according to an embodiment may obtain a normal purchase unit price and the lowest normal purchase unit price for each of heavyweight iron scrap A, heavyweight iron scrap B, lightweight iron scrap A, and lightweight iron scrap B. Referring to FIG. 4, for example, the device 100 may determine that a first type of iron scrap of the mixed iron scrap corresponds to the heavyweight iron scrap A, a second type of iron scrap corresponds to the heavyweight iron scrap B, and a mixed loading ratio of the first type of iron scrap of the mixed iron scrap to the second type of iron scrap is 8:2. Further, the device 100 may determine a weighted average unit price for the mixed iron scrap based on the percentage of the first type of iron scrap, the percentage of the second type of iron scrap, and the normal purchase unit prices, as described above in operation S230. Therefore, the device 100 may determine the weighted average unit price for the mixed iron scrap as 483 KRW (485×0.8+475×0.2) per 1 kg. Further, the device 100 may determine that the weighted average unit price for the mixed iron scrap is greater than 482 KRW per 1 kg, which is the lowest normal purchase unit price for the heavyweight iron scrap A, which is the first type of iron scrap. Therefore, the device 100 may determine the grade for the mixed iron scrap to be the first grade.

Further, in an embodiment, when the weighted average unit price is smaller than the lowest normal purchase unit price, the device 100 may determine the grade for the mixed iron scrap to be the second grade. In an embodiment, the lowest normal purchase unit price may represent the lowest normal purchase unit price for the first type of iron scrap.

Referring to FIG. 4, for example, the device 100 may determine that the first type of iron scrap of the mixed iron scrap corresponds to the heavyweight iron scrap A, the second type of iron scrap corresponds to the heavyweight iron scrap B, and the mixed loading ratio of the first type of iron scrap of the mixed iron scrap to the second type of iron scrap is 6:4. Therefore, the device 100 may determine the weighted average unit price for the mixed iron scrap as 481 KRW (485×0.6+475×0.4) per 1 kg. Further, since the device 100 can determine that the weighted average unit price for the mixed iron scrap is less than 482 KRW per 1 kg, which is the lowest normal purchase unit price for the heavyweight iron scrap A, which is the first type of iron scrap, the device 100 may determine the grade for the mixed iron scrap to be the second grade.

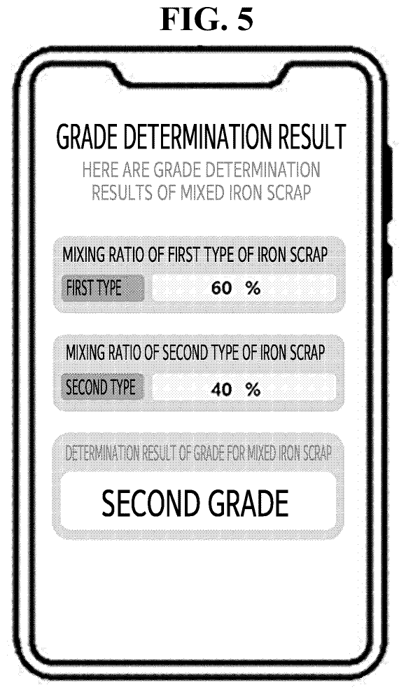

FIG. 5 is an example of a screen display through which the device 100 according to an embodiment of the present disclosure provides a result of determination of a grade for mixed iron scrap.

Referring to FIG. 5, in an embodiment, the device 100 may provide the result of determination of the grade for the mixed iron scrap mixed in and loaded on the loading device through a display screen. In an embodiment, the device 100 may determine the percentage of the first type of iron scrap and the percentage of the second type of iron scrap as 6:4, and as described in the example above, the device 100 may determine the weighted average unit price for the mixed iron scrap as 481 KRW per 1 kg. Further, the device 100 may determine that the weighted average unit price for the mixed iron scrap is less than 482 KRW per 1 kg, which is the lowest normal purchase unit price, which means the threshold weighted average unit price. Therefore, in an embodiment, the device 100 may determine the grade for the mixed iron scrap to be the second grade corresponding to the second type of iron scrap. Further, the device 100 may provide the result of determination of the determined grade for the mixed iron scrap on the display screen to prevent errors occurring in a final grade determination process directly performed by a person through an inspector, as in the related art, and always determine and provide the grade for the mixed iron scrap consistently and accurately. Therefore, the accuracy of the result of determination of the grade for the mixed iron scrap can be improved, thereby improving user convenience and satisfaction.

The device 100 according to an embodiment may determine a purchase unit price difference value representing a difference between a first normal purchase unit price for the first type of iron scrap and a second normal purchase unit price for the second type of iron scrap in the operation of determining the lowest normal purchase unit price. Further, the device 100 may determine the lowest normal purchase unit price by applying the acceptable mixed loading ratio to the purchase unit price difference value.

Referring to FIG. 5, the device 100 according to an embodiment may obtain policy information on criteria for determining the grade for the mixed iron scrap from the receiving unit 110. Further, the device 100 may determine a corresponding normal purchase unit price for each type of iron scrap based on the policy information. Therefore, the device 100 may determine the purchase unit price difference value representing a difference between the normal purchase unit prices for each iron scrap. For example, the device 100 may determine that the first type of iron scrap corresponds to the heavyweight iron scrap A and the second type of iron scrap corresponds to the heavyweight iron scrap B. In this case, the normal purchase unit price for the heavyweight iron scrap A corresponds to 485 KRW per 1 kg and the normal purchase unit price for the heavyweight iron scrap B corresponds to 475 KRW per 1 kg, and thus the device 100 may determine the purchase unit price difference value to be 10 KRW per 1 kg.

The device 100 according to an embodiment may determine an acceptable threshold value corresponding to the product of the purchase unit price difference value and an unacceptable ratio determined according to the acceptable mixed loading ratio in the operation of determining the lowest normal purchase unit price by applying the acceptable mixed loading ratio to the purchase unit price difference value. Further, the device 100 may determine the lowest normal purchase unit price to correspond to a value obtained by subtracting the acceptable threshold value from the first normal purchase unit price.

Referring to FIG. 5, the device 100 according to an embodiment may determine the purchase unit price difference value, which represents the difference between the normal purchase unit prices, as 10 KRW per 1 kg. Further, the device 100 may determine the first type of iron scrap of the mixed iron scrap as the heavyweight iron scrap A, and the second type of iron scrap as the heavyweight iron scrap B. Further, the device 100 may determine that the acceptable mixed loading ratio of the first type of iron scrap to the second type of iron scrap is 7:3. Therefore, in this case, the unacceptable ratio may be 30% on the basis of the acceptable mixed loading ratio of the mixed iron scrap to the second type of iron scrap. The device 100 may determine the acceptable threshold value to be 3 (3 KRW per 1 kg) corresponding to the product of the difference between the unacceptable ratio and the purchase unit price difference value, and may determine the lowest normal purchase unit price to correspond to 482 KRW per 1 kg, which is the first normal purchase unit price of 485 KRW per 1 kg minus the acceptable threshold value of 3.

Therefore, even when the normal purchase unit price for each grade for iron scrap fluctuates depending on the market conditions, the device 100 may determine the lowest normal purchase unit price based on the purchase unit price difference value representing the difference between the normal purchase unit prices for different grades and the acceptable mixed loading ratio and determine the grade for the mixed iron scrap by comparing the weighted average unit price for the mixed iron scrap with the lowest normal purchase unit price, thereby stably providing the information.

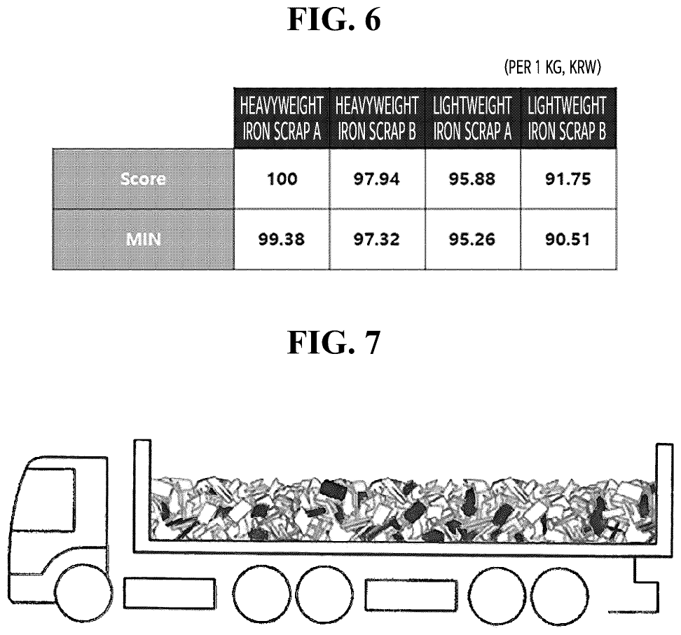

FIG. 6 is an example of a table showing score cards determined based on policy information and provided by the device according to an embodiment of the present disclosure.

Referring to FIG. 6, the score cards are values obtained by converting a normal purchase unit price for the highest grade type of iron scrap into 100 based on the normal purchase unit price for iron scrap based on the policy information of FIG. 4 and the lowest normal purchase unit price and converting all the values shown in FIG. 4 based on that criteria. For example, as shown in FIGS. 4 and 5, the device 100 may determine the score of the heavyweight iron scrap A as 100. Further, the device 100 may determine the score of the heavyweight iron scrap B as 97.94 by applying a calculation formula that converts 485 KRW per 1 kg to 100. In this case, the device 100 may determine to round off the number in the third decimal place when the normal purchase unit price corresponding to each type of iron scrap is converted into a score value. Therefore, in an embodiment, the device 100 may obtain company-specific policy information through a plurality of company accounts and determine the value of the score card based on the policy information. The device 100 may provide a technology for always determining constant and automatic prices by applying the value of the score card even when the normal purchase unit price for iron scrap by company and the acceptable mixed loading ratio change depending on the market conditions, thereby improving the user satisfaction.

FIG. 7 is an example of a loading device on which mixed iron scrap is loaded according to an embodiment of the present disclosure.

FIG. 8 is a view of an example of the loading device on which mixed iron scrap is loaded according to an embodiment of the present disclosure from above.

Referring to FIGS. 7 and 8, as described above in operation S230, the device 100 may further support an iron scrap analysis processor. The device 100 may determine the iron scrap classification information on the mixed iron scrap mixed and loaded in the loading device through an iron scrap analysis process. That is, the device 100 may support a processor that provides both the information related to the grade for the mixed iron scrap and the iron scrap classification processor. Further, the device 100 may determine and provide the grade for the mixed iron scrap based on the iron scrap classification information and the policy information obtained from the plurality of company accounts, and thus errors that occur when a person directly inspects complexly the mixed iron scrap and determines the grade of the mixed iron scrap without accurate criteria can be reduced, and information can be provide without errors using determination results determined by artificial intelligence (AI) without the hassle of manual inspection, thereby improving the accuracy of information.

Referring to FIGS. 1 and 2, in an embodiment, the receiving unit 110 is a functional component configured to obtain and process input data necessary for determining the grade of mixed iron scrap. The receiving unit serves as an interface for acquiring information such as policy criteria, material composition data, and pricing parameters from various sources.

In an implementation, the receiving unit 110 may include a software-based module that accepts data directly through a user interface. For example, it can receive policy information, including acceptable mixed loading ratios, normal purchase unit prices for various iron scrap types, and other relevant criteria, entered manually by users.

In another implementation, the receiving unit 110 may be integrated with hardware components, such as weight sensors, image recognition cameras, or barcode/RFID scanners, to automate the collection of real-time measurement data. For instance, the receiving unit may interface with industrial weight sensors to determine the total weight of mixed iron scrap loaded onto a truck bed or platform. Similarly, it may receive data from vision-based systems that analyze images of scrap materials to identify the composition and percentage of different scrap types.

The receiving unit 110 may also connect to external systems through network communication protocols, such as HTTP, FTP, or APIs, to retrieve dynamic data. For example, the receiving unit may fetch real-time pricing information from an online market database or obtain historical purchase data from an enterprise resource planning (ERP) system. In such cases, the receiving unit ensures the timely synchronization of input data to account for market fluctuations or company-specific policies.

Referring to FIG. 8, in an embodiment, the loading device is a physical component designed to hold and facilitate the inspection, measurement, and analysis of mixed iron scrap. In an implementation, the loading device serves as the platform on which the scrap material is placed for evaluation, providing a controlled environment for gathering data such as weight, composition, and material proportions (or referred collectively as “measurement data”). The loading device may take the form of a truck bed, conveyor belt, or automated loading platform. The loading device may also include a mechanism for capturing specific attributes, such as density or size, through specialized tools like laser measurement devices or thickness gauges.

In an embodiment, the receiving unit and the loading device work together to determine the grade of mixed iron scrap. The loading device provides the physical platform where the scrap is placed for inspection and measurement, while the receiving unit serves as the interface for receiving the measurement data that is processed by the processor 120. The measurement data may be transmitted by the loading device or sources external thereto.

In an implementation, the loading device may be equipped with hardware features such as weight sensors and imaging systems to facilitate the collection of data. For example, when mixed iron scrap is loaded onto a truck bed, conveyor belt, or static platform, the loading device measures the total weight and may utilize cameras or scanners to capture images for visual analysis. These tools enable the system to identify the types and proportions of different scrap materials present in the load.

In an implementation, the receiving unit may act as a data acquisition gateway, capturing the measurements and analysis results from the loading device and integrating them with other necessary input data. For example, the receiving unit collects weight data from sensors and compositional data from imaging systems located on the loading device. Additionally, the receiving unit can accept policy information, such as acceptable mixed loading ratios and normal purchase unit prices, either through manual user input or by retrieving it from external databases or networked systems. This allows the receiving unit to combine real-time data from the loading device with contextual information necessary for accurate grade determination.

In an embodiment, the integration of the receiving unit and the loading device enables seamless data flow. For example, in a recycling facility, the loading device might analyze scrap material as it moves along a conveyor belt, automatically transmitting weight and compositional data to the receiving unit. The receiving unit then validates this data, compares it with predefined policy criteria, and sends it to the processor for determining the weighted average unit price and the scrap grade.

By working in tandem, in an embodiment, the receiving unit and the loading device eliminate the need for manual inspections, reducing errors and improving efficiency. The loading device provides the physical and measurement capabilities, while the receiving unit ensures that the collected data is processed and integrated with other input parameters, enabling consistent and reliable determination of mixed iron scrap grades. Accordingly, the embodiments of the present disclosure support automation, reduces processing time, and enhances the accuracy of the grade determination process.

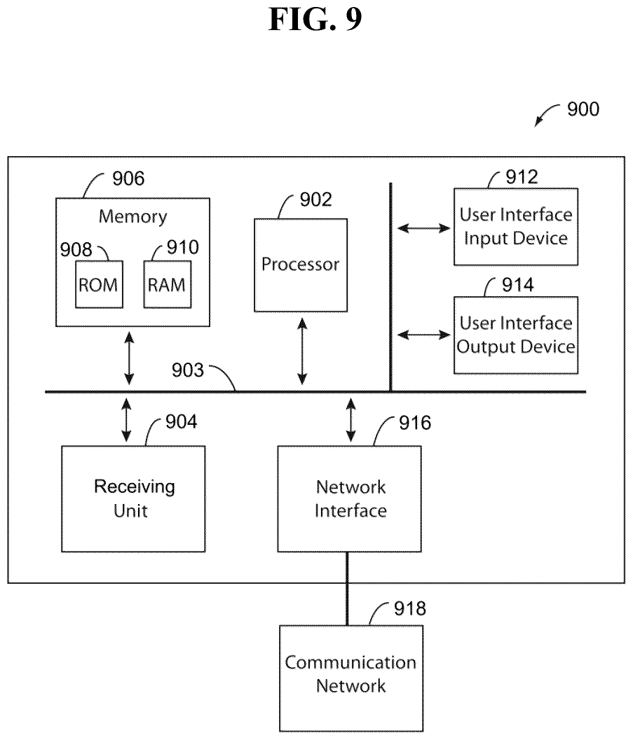

FIG. 9 shows a simplified view of a device 900 that corresponds to the device 100 illustrated in FIG. 1, according to an embodiment of the present disclosure. The device 900 comprises a processor 902 and a receiving unit 904 that are in communication with each other via a bus 903. The device 900 may also include a memory 906. The memory may include a Read Only Memory (ROM) 204 and a Random Access Memory (RAM) 206. The device may further include a user interface input device 912 (e.g. a keyboard, mouse, or touch screen) and a user interface output device 914 such as a display screen. In an implementation, the user interface input device 912 and the user interface output device 914 may be integrated together, e.g., a touch display screen. A network interface 916 is configured to allow information to be communicated between the device 900 and a loading device (not shown) via a communications network 918.

Various embodiments of the present disclosure may be implemented as software including one or more instructions stored in a storage medium (e.g., a memory) that can be read by a machine (e.g., a display device or a computer). For example, a processor (e.g., the processor 220) of the machine may call at least one of the stored instructions from the storage medium and execute the instructions. This enables the device to operate to perform at least one function in accordance with the at least one called instruction. The one or more instructions may include code generated by a compiler or code executable by an interpreter. The storage medium readable by the device may be provided in the form of a non-transitory storage medium. Here, the term “non-transitory” means only that the storage medium is a tangible device and does not contain signals (e.g., electromagnetic waves), and this term does not distinguish between a case where data is stored semi-permanently and a case where data is stored temporarily in the storage medium.

According to an embodiment, the method according to various embodiments disclosed in the present disclosure may be included in a computer program product and provided. The computer program product may be traded between a seller and a buyer as a commodity. The computer program product may be distributed in the form of a machine-readable storage medium (e.g., a compact disc read-only memory (CD-ROM)), or may be distributed online (e.g., by download or upload) through an application store (e.g., Play Store™) or directly between two user devices (e.g., smartphones). In the case of online distribution, at least a portion of the computer program product may be temporarily stored or temporarily generated in a machine-readable storage medium, such as a memory of a manufacturer's server, an application store's server, or an intermediary server.

According to an embodiment of the present disclosure, by determining a grade for iron scrap in which a plurality types of iron are mixed and supporting a user to receive related information, user satisfaction can be improved.

Further, by determining and providing a grade for mixed iron scrap based on an acceptable mixed loading criterion for iron scrap by steelmaker, a mixed loading ratio, and a purchase unit price for each grade, the efficiency of information provision can be improved.

Effects of the present disclosure are not limited to the above-described effects and other effects that are not described may be clearly understood by those skilled in the art from the above detailed descriptions.

While the present disclosure has been described with reference to the accompanying drawings, it is not limited to the disclosed embodiments and drawings, and it will be understood by those skilled in the art that various changes in form and details may be made without departing from the spirit and scope of the present disclosure. Therefore, the disclosed methods should be considered from an exemplary point of view for description rather than a limiting point of view. Even when the embodiments are described and the effects according to the configuration of the present disclosure are not explicitly described, effects that may be predicted by the configuration may also be recognized. The scope of the present disclosure is defined not by the detailed description of the present disclosure but by the appended claims and encompasses all modifications and equivalents that fall within the scope of the appended claims and will be construed as being included in the present disclosure.

What is claimed is:

1. A method of providing information related to a grade for mixed iron scrap using a device, the method comprising:
obtaining, by a receiving unit, policy information on criteria for determining a grade for mixed iron scrap in which a first type of iron scrap and a second type of iron scrap are mixed;
determining, by a processor, a normal purchase unit price for each of the first type of iron scrap and the second type of iron scrap based on the policy information;
determining, by the processor, a weighted average unit price for the mixed iron scrap based on a percentage of the first type of iron scrap, a percentage of the second type of iron scrap, and the normal purchase unit price for each type of iron scrap; and
determining, by the processor, the grade for the mixed iron scrap to be a first grade corresponding to the first type of iron scrap or a second grade corresponding to the second type of iron scrap based on a result of comparing a threshold weighted average unit price determined based on the policy information with the weighted average unit price.

2. The method of claim 1, wherein the policy information includes information on an acceptable mixed loading ratio indicating an acceptable mixed loading criterion between a plurality of iron scrap grades for the mixed iron scrap, and
wherein the determining the grade for the mixed iron scrap is based on measurement data received by the receiving unit, the measurement data being including a weight of the mixed iron scrap.

3. The method of claim 2, further comprising: determining, by the processor, a lowest normal purchase unit price, which represents a lowest value of the normal purchase unit price for the first type of iron scrap, based on the policy information,
wherein the lowest normal purchase unit price represents the threshold weighted average unit price.

4. The method of claim 3, wherein the first grade of the first type of iron scrap is higher than the second grade of the second type of iron scrap.

5. The method of claim 1, wherein the determining of the grade for the mixed iron scrap to be either the first grade or the second grade includes:
determining, by the processor, the grade for the mixed iron scrap to be the first grade when the weighted average unit price is greater than the lowest normal purchase unit price; and
determining, by the processor, the grade for the mixed iron scrap to be the second grade when the weighted average unit price is less than the lowest normal purchase unit price.

6. The method of claim 3, wherein the determining of the lowest normal purchase unit price includes:
determining, by the processor, a purchase unit price difference value representing a difference between a first normal purchase unit price for the first type of iron scrap and a second normal purchase unit price for the second type of iron scrap; and
determining, by the processor, the lowest normal purchase unit price by applying the acceptable mixed loading ratio to the purchase unit price difference value.

7. The method of claim 6, wherein the determining of the lowest normal purchase unit price by applying the acceptable mixed loading ratio to the purchase unit price difference value includes:
determining, by the processor, an acceptable threshold value corresponding to the product of the purchase unit price difference value and an unacceptable ratio determined according to the acceptable mixed loading ratio; and
determining, by the processor, the lowest normal purchase unit price to correspond to a value obtained by subtracting the acceptable threshold value from the first normal purchase unit price.

8. A device for providing information related to a grade for mixed iron scrap, the device comprising:
a receiving unit configured to obtain policy information and measurement data, the policy information relating to criteria for determining a grade for mixed iron scrap in which a first type of iron scrap and a second type of iron scrap are mixed, the measurement data relating to a characteristic of the mixed iron scrap; and
a processor that is configured to:
determine a normal purchase unit price for each of the first type of iron scrap and the second type of iron scrap based on the policy information;
determine a weighted average unit price for the mixed iron scrap based on a percentage of the first type of iron scrap, a percentage of the second type of iron scrap, and the normal purchase unit prices; and
determine the grade for the mixed iron scrap to be either a first grade corresponding to the first type of iron scrap or a second grade corresponding to the second type of iron scrap based on a result of comparing a threshold weighted average unit price determined based on the policy information with the weighted average unit price.

9. The device of claim 8, wherein the policy information includes information on an acceptable mixed loading ratio indicating an acceptable mixed loading criterion between a plurality of iron scrap grades for the mixed iron scrap.

10. The device of claim 9, wherein the processor determines a lowest normal purchase unit price, which represents a lowest value of the normal purchase unit price for the first type of iron scrap, based on the policy information.

11. The device of claim 8, wherein the processor is configured to:
determine the grade for the mixed iron scrap to be the first grade when the weighted average unit price is greater than the lowest normal purchase unit price; and
determine the grade for the mixed iron scrap to be the second grade when the weighted average unit price is less than the lowest normal purchase unit price.

12. The device of claim 10, wherein the processor is configured to:
determine a purchase unit price difference value representing a difference between a first normal purchase unit price for the first type of iron scrap and a second normal purchase unit price for the second type of iron scrap; and
determine the lowest normal purchase unit price by applying the acceptable mixed loading ratio to the purchase unit price difference value.

13. A computer-readable recording medium on which a program is recorded, the program comprising instructions that, when executed by a processor, cause the processor to:
obtain policy information on criteria for determining a grade for mixed iron scrap in which a first type of iron scrap and a second type of iron scrap are mixed;
determine a normal purchase unit price for each of the first type of iron scrap and the second type of iron scrap based on the policy information;
determine a weighted average unit price for the mixed iron scrap based on a percentage of the first type of iron scrap, a percentage of the second type of iron scrap, and the normal purchase unit price for each type of iron scrap; and
determine the grade for the mixed iron scrap to be either a first grade corresponding to the first type of iron scrap or a second grade corresponding to the second type of iron scrap based on a result of comparing a threshold weighted average unit price determined based on the policy information with the weighted average unit price.

14. The computer-readable recording medium of claim 13, wherein the policy information includes information on an acceptable mixed loading ratio indicating an acceptable mixed loading criterion between a plurality of iron scrap grades for the mixed iron scrap, and
wherein the determining the grade for the mixed iron scrap is based on measurement data received by the receiving unit, the measurement data being including a weight of the mixed iron scrap.

15. The computer-readable recording medium of claim 14, the program further comprising instructions that, when executed by a processor, cause the processor to:
determine a lowest normal purchase unit price, which represents a lowest value of the normal purchase unit price for the first type of iron scrap, on the basis of based on the policy information,
wherein the lowest normal purchase unit price represents the threshold weighted average unit price.

16. The computer-readable recording medium of claim 15, wherein the first grade of the first type of iron scrap is higher than the second grade of the second type of iron scrap.

17. The computer-readable recording medium of claim 13, wherein the instructions to determine the grade for the mixed iron scrap to be either the first grade or the second grade, when executed by a processor, cause the processor to:
determine the grade for the mixed iron scrap to be the first grade when the weighted average unit price is greater than the lowest normal purchase unit price; and
determine the grade for the mixed iron scrap to be the second grade when the weighted average unit price is less than the lowest normal purchase unit price.

18. The computer-readable recording medium of claim 15, wherein the instructions for determining the lowest normal purchase unit price, when executed by a processor, cause the processor to:
determine a purchase unit price difference value representing a difference between a first normal purchase unit price for the first type of iron scrap and a second normal purchase unit price for the second type of iron scrap; and
determine the lowest normal purchase unit price by applying the acceptable mixed loading ratio to the purchase unit price difference value.

19. The computer-readable recording medium of claim 18, wherein the instructions for determining the lowest normal purchase unit price by applying the acceptable mixed loading ratio to the purchase unit price difference value, when executed by a processor, cause the processor to:
determine an acceptable threshold value corresponding to the product of the purchase unit price difference value and an unacceptable ratio determined according to the acceptable mixed loading ratio; and
determine the lowest normal purchase unit price to correspond to a value obtained by subtracting the acceptable threshold value from the first normal purchase unit price.
